(19) United States
(12) Patent Application Publication
(10) Pub. No.: US 2025/0259792 A1
(43) Pub. Date: Aug. 14, 2025

(54) MULTILAYER CERAMIC CAPACITOR AND MANUFACTURING METHOD OF MULTILAYER CERAMIC CAPACITOR

(71) Applicant: Murata Manufacturing Co., Ltd., Nagaokakyo-shi (JP)

(72) Inventor: Hayato FUKUSHIMA, Nagaokakyo-shi (JP)

(21) Appl. No.: 19/196,117

(22) Filed: May 1, 2025

Related U.S. Application Data
(63) Continuation of application No. PCT/JP2024/002538, filed on Jan. 27, 2024.

(30) Foreign Application Priority Data
Mar. 11, 2023 (JP) 2023-038186

(51) Int. Cl. H01G 4/224; C04B 35/468; C04B 35/48; H01G 4/012; H01G 4/12; H01G 4/30

(52) U.S. Cl. CPC H01G 4/224; C04B 35/4682; C04B 35/48; H01G 4/012; H01G 4/1227; H01G 4/30

(57) ABSTRACT

A multilayer ceramic capacitor includes a ceramic body including a ceramic layer, and first and second internal electrodes, and first and second external electrodes on end surfaces of the ceramic body. The first and second internal electrodes are respectively electrically connected to the first and second external electrodes. The ceramic body includes a capacitance forming portion with a rectangular or substantially rectangular parallelepiped shape with six surfaces, a non-capacitance forming portion outside on each of the six surfaces of the capacitance forming portion, and a surface protective layer outside on at least a portion of the non-capacitance forming portion and at least exposed from the first and second main surfaces and the first and second side surface, the surface protective layer including a ceramic with a composition different from a composition of the ceramic of the non-capacitance forming portion.

### CROSS REFERENCE TO RELATED APPLICATIONS

This application claims the benefit of priority to Japanese Patent Application No. 2023-038186 filed on Mar. 11, 2023 and is a Continuation Application of PCT Application No. PCT/JP2024/002538 filed on Jan. 27, 2024. The entire contents of each application are hereby incorporated herein by reference.

### BACKGROUND OF THE INVENTION

### 1. Field of the Invention

The present invention relates to multilayer ceramic capacitors, and manufacturing methods suitable for manufacturing multilayer ceramic capacitors.

### 2. Description of the Related Art

Multilayer ceramic capacitors are widely used in electronic devices, electric devices, and the like.

A conventional multilayer ceramic capacitor includes a ceramic body in which a ceramic layer, a first internal electrode and a second internal electrode are stacked in the height direction. The ceramic body includes a first main surface and a second main surface facing each other in the height direction, a first side surface and a second side surface facing each other in the width direction, and a first end surface and a second end surface facing each other in the length direction. In the ceramic body, the first internal electrode extends to the first end surface, and the second internal electrode extends to the second end surface. A first external electrode is formed on one end of the ceramic body and electrically connected to the first internal electrode, and a second external electrode is formed on the other end of the ceramic body and electrically connected to the second internal electrode.

The ceramic body includes a capacitance forming portion which contributes to the formation of capacitance and is formed such that the first internal electrode and the second internal electrode face each other with the ceramic layer interposed therebetween. The ceramic body includes a protective layer between the capacitance forming portion and the first main surface and the second main surface, the protective layer is formed from only a ceramic layer, and is not formed with the first internal electrode and the second internal electrode. The ceramic body includes a side gap between the capacitance forming portion and the first side surface and the second side surface, the side gap is formed from only a ceramic layer, and is not formed with the first internal electrode and the second internal electrode. The side gap is configured to prevent the first internal electrode and the second internal electrode from being exposed from the first side surface and the second side surface. The ceramic body also includes a lead-out portion between the capacitance forming portion and the first end face, the lead-out portion being formed only from the first internal electrode and the ceramic layer and not formed with the second internal electrode, and a lead-out portion between the capacitance forming portion and the second end face, the lead-out portion being formed only from the second internal electrode and the ceramic layer and not formed with the first internal electrode. In the present application, the protective layer, the side gap and the lead-out portion may be referred to as a non-capacitance forming portion.

In a conventional multilayer ceramic capacitor, it is quite often that the ceramic for forming the capacitance forming portion has the same composition as the ceramic for forming the non-capacitance forming portion (a protective layer, a side gap, and a lead-out portion). Specifically, for example, a ceramic green sheet to which a conductive paste for forming the first internal electrode is applied in a desired pattern, a ceramic green sheet to which a conductive paste for forming the second internal electrode is applied in a desired pattern, and a ceramic green sheet to which no conductive paste is applied are prepared, stacked in a predetermined order, and fired to produce a ceramic body. In this case, there is only one type of ceramic green sheet, and by using the same ceramic for all the ceramic green sheets, the capacitance forming portion and the non-capacitance forming portion are made of ceramics having the same composition.

In the case where the same type (one type) of ceramic is used for all the ceramic green sheets, in the firing step of the ceramic body, in order to improve the quality of the ceramic of the capacitance forming portion, a firing profile such as a firing temperature and a firing time is usually determined suitable for the ceramic of the capacitance forming portion. This is because the quality of the ceramic of the capacitance forming portion greatly affects the electrical characteristics such as the capacitance of the multilayer ceramic capacitor. Since the capacitance forming portion and the non-capacitance forming portion have different structures (due to presence or absence of internal electrodes or the like), the optimum firing profiles are often different.

As a result, even if the ceramic of the capacitance forming portion is formed to have a good quality with an appropriate particle size, the ceramic of the non-capacitance forming portion (particularly, the protective layer and the side gap) may have a low quality with an excessively large particle size.

If the ceramic of the non-capacitance forming portion is over-fired and the particle size becomes too large, there is a concern that the strength of the first main surface, the second main surface, the first side surface, and the second side surface of the ceramic body may decrease. Since the first end surface and the second end surface of the ceramic body are formed with the first external electrode and the second external electrode and are protected by the same, the decrease in the strength of the first end surface and the second end surface is smaller than the decrease in the strength of the first main surface, the second main surface, the first side surface, and the second side surface.

The decrease in the strength of the outer surface of the ceramic body is a serious defect in the quality of the multilayer ceramic capacitor. This is because, when an external force is applied to the ceramic body, a crack or a chip may occur in the ceramic body. When a crack or a chip occurs in the ceramic body, moisture may infiltrate into the ceramic body, causing the multilayer ceramic capacitor to fail.

Therefore, efforts have been made to improve the strength of the outer surface of the ceramic body in the multilayer ceramic capacitor.

For example, in the multilayer ceramic capacitor (multilayer electronic device) described in Japanese Patent Laid-Open No. 2011-035145, the strength of the outer surface of the ceramic body is improved by forming each portion of a single ceramic body using two different types of ceramics with different compositions. Specifically, for example, in the multilayer ceramic capacitor illustrated in FIG. 6 of Japanese Patent Laid-Open No. 2011-035145, a ceramic having a composition that has a good dielectric constant is used to form a capacitance forming portion between the first internal electrode and the second internal electrode, while a ceramic that has a high strength is used to form a non-capacitance forming portion on the outer surface of the ceramic body, which improves the strength of the outer surface of the ceramic body.

In the multilayer ceramic capacitor described in Japanese Patent Laid-Open No. 2012-004236, a single ceramic body is produced using one type of ceramic green sheet, but a water-soluble binder resin is added to the ceramic green sheet in advance, and before the firing step, the outer surface of the unfired ceramic body is brought into contact with water or the like to elute specific elements from the outer surface of the unfired ceramic body, making the composition of the ceramic for the outer surface of the fired ceramic body different from the composition of the ceramic for the capacitance forming portion of the ceramic body. This makes the ceramic for the outer surface of the fired ceramic body high in strength.

In the multilayer ceramic capacitor described in Japanese Patent Application Laid-Open No. 2007-266223, ceramics having different compositions are used to prepare a ceramic green sheet for forming a capacitance forming portion and a side gap and to prepare a ceramic green sheet for forming a protective layer to be stacked on and under the former ceramic green sheet. A ceramic having a composition suitable for exhibiting a good dielectric constant is used to prepare the ceramic green sheet for forming the capacitance forming portion and the side gap, and a ceramic that exhibits high strength is used to prepare the ceramic green sheet for forming the protective layer.

In the multilayer ceramic capacitor of Japanese Patent Laid-Open No. 2011-035145, since each portion of a single ceramic body is formed by using two different types of ceramics with different compositions, the manufacturing process becomes complicated. In particular, the use of ceramics having different compositions to prepare the capacitor forming portion and the side gap makes the manufacturing process extremely complicated and difficult. The multilayer ceramic capacitor of Japanese Patent Laid-Open No. 2011-035145 has a problem of low productivity.

The multilayer ceramic capacitor of Japanese Patent Laid-Open No. 2012-004236 also has a problem of low productivity. In other words, a water-soluble binder resin must be added to the ceramic green sheet in advance, and prior to the firing step of the ceramic body, the outer surface of the unfired ceramic body must be brought into contact with water or the like to elute specific elements from the outer surface of the unfired ceramic body, which also makes the manufacturing process complicated. In addition, the step of bringing the outer surface of the unfired ceramic body into contact with water or the like to elute specific elements is difficult to control, and if the step is not controlled appropriately, there is a concern that the strength of the outer surface of the ceramic body may become irregular or the electrical properties such as the capacitance may become irregular between manufactured products.

In the multilayer ceramic capacitor of Japanese Patent Laid-Open No. 2007-266223, although the strength of the first main surface and the second main surface of the ceramic body where the protective layer is exposed from the outer surface is improved, there is a problem that the strength of the first side surface and the second side surface of the ceramic body where the side gap is exposed from the outer surface is not improved. In other words, since the ceramic of the side gap has the same composition as the ceramic of the capacitance forming portion, the strength of the first side surface and the second side surface of the ceramic body may remain low.

### SUMMARY OF THE INVENTION

Example embodiments of the present invention provide multilayer ceramic capacitors that are each able to be easily manufactured with high productivity, and manufacturing methods of such multilayer ceramic capacitors.

A multilayer ceramic capacitor according to an example embodiment of the present invention includes a ceramic body, a first main surface and a second main surface facing each other in a height direction, a first side surface and a second side surface facing each other in a width direction orthogonal or substantially orthogonal to the height direction, a first end surface and a second end surface facing each other in a length direction orthogonal or substantially orthogonal to both of the height direction and the width direction, a ceramic layer, a first internal electrode, and a second internal electrode stacked in the height direction, and a first external electrode on the first end surface of the ceramic body and a second external electrode on the second end surface of the ceramic body. The first internal electrode extends to the first end surface and is electrically connected to the first external electrode, and the second internal electrode extends to the second end surface and is electrically connected to the second external electrode. The ceramic body includes a capacitance forming portion generating a capacitance and including the first internal electrode and the second internal electrode facing each other with the ceramic layer interposed therebetween, the capacitance forming portion having a rectangular or substantially rectangular parallelepiped shape including six surfaces, a non-capacitance forming portion not generating a capacitance and being located outside on each of the six surfaces of the capacitance forming portion such that the first internal electrode and the second internal electrode do not face each other with the ceramic layer interposed therebetween, and a surface protective layer outside on at least a portion of the non-capacitance forming portion and at least exposed from the first main surface, the second main surface, the first side surface, and the second side surface, the surface protective layer including a ceramic with a composition different from a composition of the ceramic of the non-capacitance forming portion.

A manufacturing method of a multilayer ceramic capacitor according to an example embodiment of the present invention includes preparing an unfired ceramic body including a first main surface and a second main surface facing each other in a height direction, a first side surface and a second side surface facing each other in a width direction orthogonal or substantially orthogonal to the height direction, a first end surface and a second end surface facing each other in a length direction orthogonal or substantially orthogonal to both of the height direction and the width direction, a ceramic green sheet, a conductive paste layer for forming a first internal electrode, and a conductive paste layer for forming a second internal electrode stacked in the height direction, applying at least one of an elemental powder or a ceramic powder to at least the first main surface, the second main surface, the first side surface, and the second side surface of the green ceramic body, firing the unfired ceramic body applied with the powder to produce a ceramic body, the ceramic body including a ceramic layer, a first internal electrode, and a second internal electrode stacked in the height direction, and forming a first external electrode electrically connected to the first internal electrode on the first end surface of the ceramic body and forming a second external electrode electrically connected to the second internal electrode on the second end surface of the ceramic body. The ceramic body thus produced includes a capacitance forming portion which generates a capacitance and includes the first internal electrode and the second internal electrode facing each other with the ceramic layer interposed therebetween, the capacitance forming portion having a rectangular or substantially parallelepiped shape with six surfaces, a non-capacitance forming portion not generating a capacitance and being outside on each of the six surfaces of the capacitance forming portion such that the first internal electrode and the second internal electrode do not face each other with the ceramic layer interposed therebetween, and a surface protective layer outside on at least a portion of the non-capacitance forming portion and at least exposed from the first main surface, the second main surface, the first side surface, and the second side surface, the surface protective layer including a ceramic with a composition different from a composition of the ceramic of the non-capacitance forming portion.

In each of multilayer ceramic capacitors according to example embodiments of the present invention, since a surface protective layer is provided on the first main surface, the second main surface, the first side surface, and the second side surface of the ceramic body, even when an external force is applied to the ceramic body, the ceramic body is prevented from cracking or chipping.

With manufacturing methods of multilayer ceramic capacitors according to example embodiments of the present invention, multilayer ceramic capacitors according to example embodiments of the present invention are able to be easily manufactured with high productivity.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor 100 according to an example embodiment of the present invention.

FIG. 2 is a cross-sectional view of the multilayer ceramic capacitor 100 according to an example embodiment of the present invention.

FIG. 3 is a cross-sectional view of the multilayer ceramic capacitor 100 according to an example embodiment of the present invention.

FIG. 4 is a cross-sectional view of a multilayer ceramic capacitor 200 according to an example embodiment of the present invention.

### DETAILED DESCRIPTION OF THE EXAMPLE EMBODIMENTS

Hereinafter, example embodiments of the present invention will be described in detail with reference to the drawings.

Each example embodiment illustrates an example of a configuration of the present invention, and the present invention is not limited to the contents described in each example embodiment. Further, the present invention may be configured by combining the contents described in different example embodiments, and such configurations are also include in the present invention. In addition, the drawings are intended to facilitate the understanding of the specification, and may be drawn schematically, and the dimensional ratios of the depicted components or between the components may not match those dimensional ratios described in the specification. In addition, the components described in the specification may be omitted in the drawings, or the components may be drawn with the number thereof omitted.

### First Example Embodiment

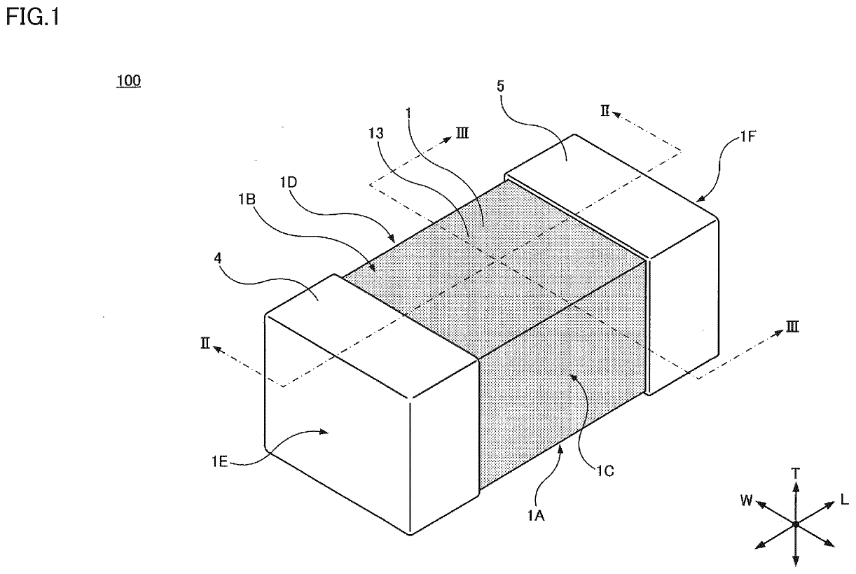

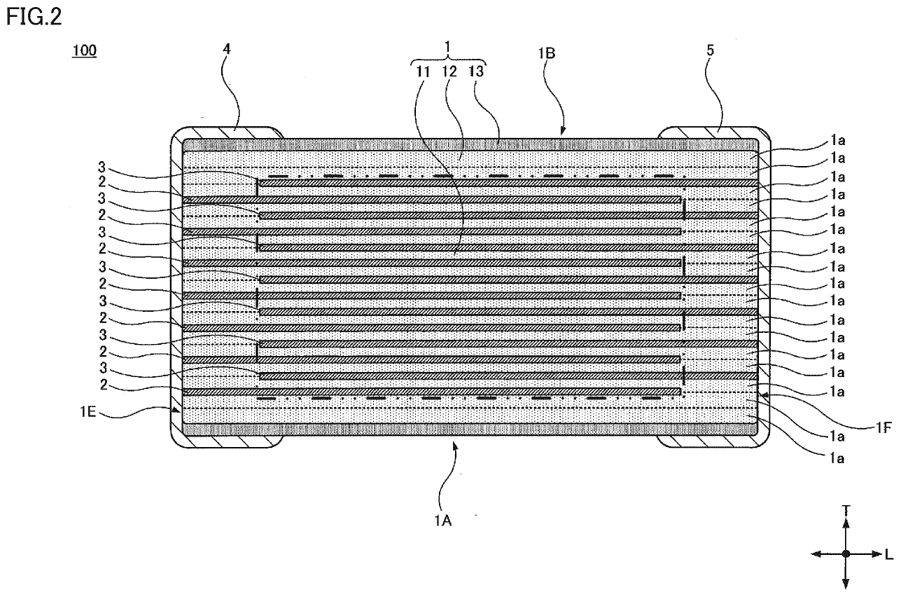

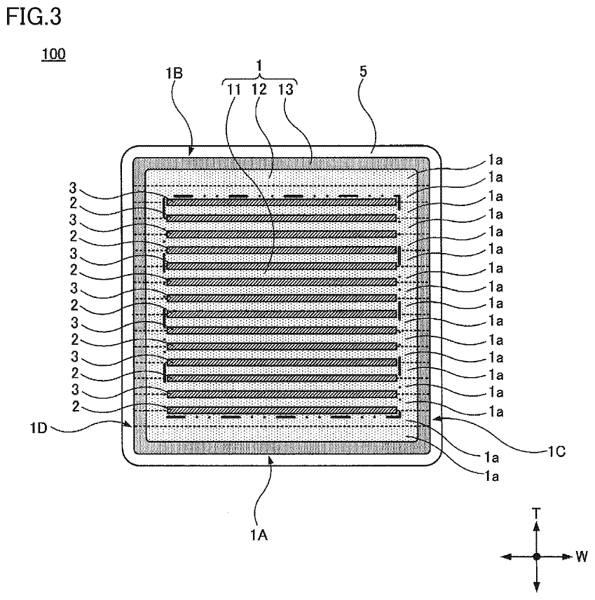

A multilayer ceramic capacitor 100 according to a first example embodiment of the present invention is illustrated in FIGS. 1 to 3. FIG. 1 is a perspective view of multilayer ceramic capacitor 100. FIG. 2 is a cross-sectional view of multilayer ceramic capacitor 100, illustrating a portion taken along a one-dot chain line II-II of FIG. 1. FIG. 3 is also a cross-sectional view of multilayer ceramic capacitor 100, illustrating a portion taken along a one-dot chain line III-III of FIG. 1. A height direction T, a width direction W, and a length direction L of multilayer ceramic capacitor 100 are illustrated in the drawings, and these directions may be referred to in the following description. In the present example embodiment, the stacking direction of ceramic layers 1a described later is defined as height direction T of multilayer ceramic capacitor 100.

Multilayer ceramic capacitor 100 includes a ceramic body 1 having a rectangular or substantially rectangular parallelepiped shape. Ceramic body 1 includes a first main surface 1A and a second main surface 1B facing each other in height direction T, a first side surface 1C and a second side surface 1D facing each other in width direction W perpendicular or substantially perpendicular to height direction T, and a first end surface 1E and a second end surface 1F facing each other in length direction L perpendicular or substantially perpendicular to both height direction T and width direction W.

Ceramic body 1 includes a plurality of ceramic layers 1a, a plurality of first internal electrodes 2, and a plurality of second internal electrodes 3, which are stacked in height direction T. First internal electrode 2 extends to first end surface 1E of ceramic body 1. Second internal electrode 3 extends to second end surface 1F of ceramic body 1.

The thickness of ceramic layer 1a is not limited, and may be, for example, about 0.3 μm to about 2.0 μm in a capacitance forming portion 11 to be described later.

Ceramic body 1 includes a capacitance forming portion 11 which generates a capacitance and includes first internal electrode 2 and second internal electrode 3 facing each other with ceramic layer 1a interposed therebetween. In FIGS. 2 and 3, capacitance forming portion 11 is indicated by a two-dot chain line. Capacitance forming portion 11 has a rectangular or substantially rectangular parallelepiped shape including six surfaces.

Ceramic body 1 includes a non-capacitance forming portion 12 which does not generate a capacitance and is provided outside on each of the six surfaces of capacitance forming portion 11 such that first internal electrode 2 and second internal electrode 3 do not face each other with ceramic layer 1a interposed therebetween. Non-capacitance forming portion 12 provided outside on each of first main surface 1A and second main surface 1B of capacitance forming portion 11 may be referred to as a protective layer. The area of the protective layer is greater than that of capacitance forming portion 11 when viewed in the planar direction. Non-capacitance forming portion 12 provided outside on each of first side surface 1C and second side surface 1D of capacitance forming portion 11 may be referred to as a side gap. Non-capacitance forming portion 12 provided outside on each of first end surface 1E and second end surface 1F of capacitance forming portion 11 may be referred to as a lead-out portion (lead-out portion of the internal electrode).

Ceramic body 1 includes a surface protective layer 13 which is provided outside on at least a portion of non-capacitance forming portion 12 and at least exposed from the first main surface 1A, second main surface 1B, first side surface 1C, and second side surface 1D. In the present example embodiment, surface protective layer 13 is provided outside on each of first main surface 1A, second main surface 1B, first side surface 1C and second side surface 1D of non-capacitance forming portion 12, and is not provided outside on first end surface 1E and second end surface 1F of non-capacitance forming portion 12. As will be described later, the composition of the ceramic of surface protective layer 13 is different from the composition of the ceramic of non-capacitance forming portion 12. Surface protective layer 13 is continuously provided outside on first main surface 1A, second main surface 1B, first side surface 1C and second side surface 1D of non-capacitance forming portion 12.

A ceramic that has a composition with a good dielectric constant is used as the ceramic of capacitance forming portion 11 of ceramic body 1. The type of the ceramic of capacitance forming portion 11 is not limited, for example, a dielectric ceramic including BaTiO₃ as a main component can be used. In the present example embodiment, a dielectric ceramic including BaTiO₃ as a main component is used as the ceramic of capacitance forming portion 11. However, instead of BaTiO₃, a dielectric ceramic including another material such as, for example, CaTiO₃, SrTiO₃, or CaZrO₃ as a main component may be used.

Although the type of the ceramic of non-capacitance forming portion 12 of ceramic body 1 is not limited, the ceramic is preferably the same as the ceramic of capacitance forming portion 11. By using the same ceramic, it becomes easier to procure, process and manage the material, which improves productivity. In the present example embodiment, a dielectric ceramic including, for example, BaTiO₃ as a main component is used as the ceramic of non-capacitance forming portion 12 which is the same as the ceramic of capacitance forming portion 11.

A ceramic with high strength is used as the ceramic of surface protective layer 13 of ceramic body 1. Although the type of the ceramic of surface protective layer 13 is not limited, in the present example embodiment, for example, particles which have a core-shell structure and including Zr (zirconium) as a shell on the surface of BaTiO₃ are used as the main component of the ceramic constituting surface protective layer 13. However, instead of (or in addition to) particles which have a core-shell structure and contain Zr as a shell on the surface of BaTiO₃, a composite of ZrO₂ (zirconium oxide or zirconia) and BaTiO₃ may be used. A ceramic including particles which have a core-shell structure and include Zr as a shell on the surface of BaTiO₃ or a ceramic including a composite of ZrO₂ or BaTiO₃ each have high strength.

The main component (i.e., metal) of first internal electrode 2 and second internal electrode 3 may be any metal, and for example, it may be Ni. However, another metal such as, for example, Cu, Ag, Pd, or Au may be used instead of Ni. Further, Ni, Cu, Ag, Pd, or Au may be alloyed with another metal. The thicknesses of first internal electrode 2 or the thickness of second internal electrode 3 is not limited, but is preferably about 0.1 to about 2.0 μm, for example.

Multilayer ceramic capacitor 100 includes a first external electrode 4 provided on one end of ceramic body 1, and a second external electrode 5 provided on the other end of ceramic body 1. More specifically, first external electrode 4 is provided on first end surface 1E of ceramic body 1, and has a cap shape with a peripheral edge thereof extending to first main surface 1A, second main surface 1B, first side surface 1C and second side surface 1D, respectively. Second external electrode 5 is provided on second end surface 1F of ceramic body 1, and has a cap shape which a peripheral edge thereof extending to first main surface 1A, second main surface 1B, first side surface 1C and second side surface 1D, respectively.

In FIGS. 2 and 3, each of first external electrode 4 and second external electrode 5 is illustrated as one layer. However, generally, first external electrode 4 and d second external electrode 5 include a plurality of layers. The number of layers, the material, the dimension, and the formation method of first external electrode 4 and second external electrode 5 are not limited. In the present example embodiment, each of first external electrode 4 and second external electrode 5 includes, for example, three layers including a base electrode layer mainly including Cu formed by baking a Cu conductive paste, a Ni-plated electrode layer provided on the base electrode layer, and a Sn-plated electrode layer provided on the Ni-plated electrode layer. However, the main component of the base electrode layer may be, for example, Ni or Ag instead of Cu. In addition, for example, Cu, Ni, Ag, or the like may be alloyed with another metal. In first external electrode 4 and second external electrode 5, the Ni-plated electrode layer is provided mainly to improve heat resistance and bondability to solder. In first external electrode 4 and second external electrode 5, the Sn plating electrode layer is mainly provided to improve solderability.

First internal electrode 2 is electrically connected to first external electrode 4. Second internal electrode 3 is electrically connected to second external electrode 5.

In multilayer ceramic capacitor 100 having the above-described configuration, since ceramics having different compositions are used for surface protective layer 13, capacitance forming portion 11 and non-capacitance forming portion 12 of ceramic body 1, it is possible to maintain the strength of ceramic body 1 by using ceramics having a composition with high strength for surface protective layer 13. In addition, in multilayer ceramic capacitor 100, ceramics since having different compositions are used for surface protective layer 13, capacitance forming portion 11 and non-capacitance forming portion 12 of ceramic body 1, it is possible to generate a high capacitance by using a ceramic with a composition with a high dielectric constant for capacitance forming portion 11 and non-capacitance forming portion 12.

In addition, in multilayer ceramic capacitor 100, since surface protective layer 13 of ceramic body 1 has high strength, even if an external force or the like is applied to ceramic body 1, ceramic body 1 is unlikely to crack or break, and thus has high moisture resistance reliability.

In multilayer ceramic capacitor 100, the ceramic of surface protective layer 13 preferably includes, for example, Zr (zirconia). Also, in multilayer ceramic capacitor 100, the ceramic of surface protective layer 13 preferably includes, for example, ZrO₂ (zirconium oxide or zirconia), and ZrO₂ include therein is more preferably stabilized ZrO₂. As a result, even if an external force is applied to ceramic body 1, it is possible to reduce or prevent more effectively cracks or chips from occurring in ceramic body 1 due to stress-induced phase transition of Zr or ZrO₂.

In multilayer ceramic capacitor 100, for example, a ceramic including particles which have a core-shell structure and include Zr as a shell on the surface of BaTiO₃ can be used as the ceramic of surface protective layer 13. In multilayer ceramic capacitor 100, for example, a ceramic including a composite of ZrO₂ and BaTiO₃ can be used as the ceramic of surface protective layer 13. As a result, surface protective layer 13 can have higher strength.

In multilayer ceramic capacitor 100, the average particle size of the ceramic of surface protective layer 13 is preferably smaller than the average particle size of the ceramic constituting non-capacitance forming portion 12. This is because if surface protective layer 13 is made of ceramic with a smaller average particle size, the strength thereof is further improved. The average particle size of the ceramic of surface protective layer 13 may be adjusted by adjusting the particle size and the amount of the raw material for forming surface protective layer 13, the type and the amount of additives added to the raw material, and the like.

The average particle size of the ceramic of non-capacitance forming portion 12 and the average particle size of the ceramic of surface protective layer 13 are measured by the following example method. First, one surface is arbitrarily selected from first main surface 1A, second main surface 1B, first side surface 1C, and second side surface 1D of ceramic body 1. Then, the thickness of non-capacitance forming portion 12 and the thickness of surface protective layer 13 on the selected surface are measured respectively. Next, at a center (an intersection point of two diagonal lines) of the selected surface, a cross section is cut out in parallel or substantially in parallel with the selected surface to a depth of about ½ of the total thickness of surface protective layer 13 to obtain a square area of about 30 μm×about 30 μm, which is used as a measurement area of surface protective layer 13. Similarly, at the center of the selected surface, a cross section is cut out in parallel or substantially in parallel with the selected surface to a depth of about ½ of the total thickness of non-capacitance forming portion 12 to obtain a square area of about 30 μm×about 30 μm, which is used as a measurement area of non-capacitance forming portion 12. Next, the measurement area (cross-section) of surface protective layer 13 is observed with an electron microscope, 10 particles are selected in descending diameter order from particles appearing in the measurement area, and an average diameter of the 10 particles is simply calculated as the average particle size of the ceramic constituting surface protective layer 13. Similarly, the measurement area (cross-section) of non-capacitance forming portion 12 is observed with an electron microscope, 10 particles are selected in descending diameter order from particles appearing in the measurement area, and an average diameter of the 10 particles is simply calculated as the average particle size of the ceramic constituting non-capacitance forming portion 12.

The average particle size of the ceramic of surface protective layer 13 is, for example, preferably about 0.35 μm or less. When the average particle size is about 0.35 μm or less, surface protective layer 13 has high strength.

In multilayer ceramic capacitor 100, the porosity of the ceramic of surface protective layer 13 is preferably greater than the porosity of the ceramic of non-capacitance forming portion 12. This is because when the porosity of the ceramic of surface protective layer 13 is high, the stress applied to ceramic body 1 can be dispersed by pores (voids) in surface protective layer 13, and thus the stress can be prevented from being propagated to non-capacitance forming portion 12 or capacitance forming portion 11. The porosity of the ceramic of surface protective layer 13 can be adjusted by adjusting the particle size and the amount of the raw material for forming surface protective layer 13, the type and the amount of additives added to the raw material, and the like.

The porosity of the ceramic of non-capacitance forming portion 12 and the porosity of the ceramic surface protective layer 13 are measured by the following example method. First, one surface is arbitrarily selected from first main surface 1A, second main surface 1B, first side surface 1C, and second side surface 1D of ceramic body 1. Then, the thickness of non-capacitance forming portion 12 and the thickness of surface protective layer 13 on the selected surface are measured respectively. Next, at the center of the selected surface, a cross section is cut out in parallel or substantially in parallel with the selected surface to a depth of about ½ of the total thickness of surface protective layer 13 to obtain a square area of about 1 μm×about 1 μm, which is used as a measurement area of surface protective layer 13. Similarly, at the center of the selected surface, a cross section is cut out in parallel or substantially in parallel with the selected surface to a depth of about ½ of the total thickness of non-capacitance forming portion 12 to obtain a square area of about 1 μm×about 1 μm, which is used as a measurement area of non-capacitance forming portion 12. Next, the measurement area (cross section) of surface protective layer 13 is observed with an electron microscope, the measurement area is divided into 10000 (=100×100) sections, and among the 10000 sections, those sections with a pore (void) area of about 50% or more are defined as pore sections. The number of pore sections divided by 10000×100(%) is simply defined as the porosity of the ceramic of surface protective layer 13. Similarly, the measurement area (cross-section) of non-capacitance forming portion 12 is observed with an electron microscope, the measurement area is divided into 10000 (=100×100) sections, and among the 10000 sections, those sections with a pore (void) area of about 50% or more are defined as pore sections. The number of pore sections divided by 10000×100(%) is simply defined as the porosity of the ceramic constituting non-capacitance forming portion 12.

In multilayer ceramic capacitor 100, the average thickness of surface protective layer 13 is, for example, preferably about 1 μm or more and about 10 μm or less. If the average thickness of surface protective layer 13 is less than about 1 μm, the surface protective layer 13 may not adequately protect the ceramic body 1. If the average thickness of surface protective layer 13 is greater than about 10 μm, the size of ceramic body 1 may become greater than necessary. The average thicknesses of surface protective layer 13 is determined by measuring the thicknesses of surface protective layer 13 at the center of each of the four surfaces of ceramic body 1, namely first main surface 1A, second main surface 1B, first side surface 1C, and second side surface 1D, and averaging the four thicknesses.

### Example Manufacturing Method of Multilayer Ceramic Capacitor 100

Multilayer ceramic capacitor 100 can be manufactured, for example, by the following method.

First, ceramic powder, binder resin, solvent, and the like are prepared and wet-mixed to prepare a ceramic slurry. In the present example embodiment, for example, BaTiO₃ powder is used as the ceramic powder.

Then, the ceramic slurry is applied to a carrier film as a sheet using a, for example, die coater, a gravure coater, a micro-gravure coater or the like, and dried to prepare a mother ceramic green sheet. In order to manufacture a large number of multilayer ceramic capacitors at one time, a large number of ceramic green sheets for manufacturing a large number of multilayer ceramic capacitors are arranged in a matrix on the mother ceramic green sheet.

Next, in order to form first internal electrodes 2, a conductive paste prepared in advance is applied to (for example, printed on) the main surface of a predetermined mother ceramic green sheet in a desired pattern. Similarly, in order to form second internal electrodes 3, a conductive paste prepared in advance is applied to the main surface of a predetermined mother ceramic green sheet in a desired pattern. No conductive paste is applied to the main surface of the predetermined mother ceramic green sheet for forming a protective layer. The conductive paste may be, for example, a mixture of metal powder (for example, Ni powder), a solvent, and a binder resin.

Next, a predetermined number of the three mother ceramic green sheets described above are stacked in a predetermined order and integrated by heating and pressing to produce an unfired ceramic mother body. The unfired ceramic mother body includes a large number of unfired ceramic bodies in a matrix.

Next, the unfired ceramic mother body is cut into strips to produce an unfired ceramic body strip that includes a group of ceramic bodies. In the unfired ceramic body strip, the first end surface and the second end surface are connected to each other between adjacent unfired ceramic bodies such that the first main surface, the second main surface, the first side surface, and the second side surface of each unfired ceramic body are exposed to the outside.

Next, an elemental powder and/or a ceramic powder are applied to the outer surface of the unfired ceramic body strip. In other words, a raw material for forming surface protective layer 13 is applied to the outer surface of the unfired ceramic body strip. In the present example embodiment, for example, Zr powder is applied as the elemental powder and/or ZrO₂ powder is applied as the ceramic powder. Additives such as, for example, a binder resin and a solvent may be added to each powder to facilitate the application.

Next, the unfired ceramic body strip is cut into individual unfired ceramic bodies. The first main surface, the second main surface, the first side surface, and the second side surface of each unfired ceramic body are applied with the elemental powder (for example, Zr powder) and/or the ceramic powder (for example, ZrO₂ powder). The unfired ceramic bodies at both ends of the unfired ceramic body strip are preferably discarded because unnecessary powder may be applied to the first end surface and the second end surface thereof.

Next, each unfired ceramic body is fired with a predetermined profile to produce ceramic body 1. At this time, the elemental powder (Zr powder) and/or the ceramic powder (ZrO₂ powder) reacts with or is mixed with the ceramic include in the unfired ceramic body (ceramic green sheet) to form surface protective layer 13 on first main surface 1A, second main surface 1B, first side surface 1C, and second side surface 1D of ceramic body 1. Specifically, surface protective layer 13 is formed by, for example, particles which have a core-shell structure and contain Zr as a shell on the surface of BaTiO₃, or a ceramic including a composite of ZrO₂ and BaTiO₃. However, the ceramic of surface protective layer 13 is not limited thereto.

Next, first external electrode 4 and second external electrode 5 are formed, for example, by baking a Cu conductive paste to form a base electrode layer on both ends of ceramic body 1, forming a Ni-plated electrode layer on the base electrode layer, and forming a Sn-plated electrode layer on the Ni-plated electrode layer, whereby multilayer ceramic capacitor 100 is manufactured.

### Second Example Embodiment

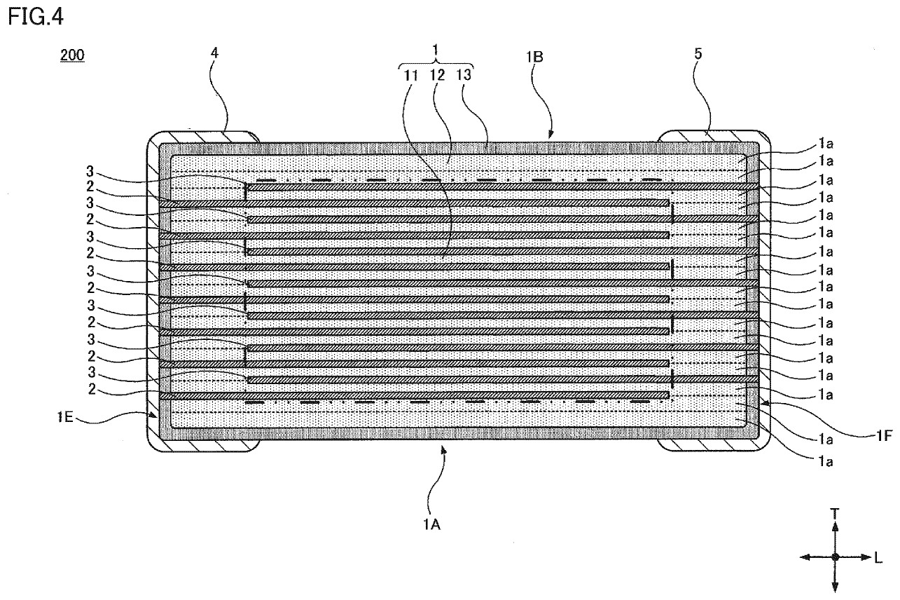

FIG. 4 illustrates a multilayer ceramic capacitor 200 according to a second example embodiment of the present invention. FIG. 4 is a perspective view of multilayer ceramic capacitor 200.

Multilayer ceramic capacitor 200 according to the second example embodiment is obtained by partially modifying the configuration of multilayer ceramic capacitor 100 according to the first example embodiment. Specifically, in multilayer ceramic capacitor 100, surface protective layer 13 is provided on first main surface 1A, second main surface 1B, first side surface 1C, and second side surface 1D of ceramic body 1. However, in multilayer ceramic capacitor 200, surface protective layer 13 is provided on first main surface 1A, second main surface 1B, first side surface 1C, second side surface 1D, the first end surface, and the second end surface of ceramic body 1. Surface protective layer 13 is continuously provided on first main surface 1A, second main surface 1B, first side surface 1C, second side surface 1D, the first end surface, and the second end surface of ceramic body 1.

In the example manufacturing method of multilayer ceramic capacitor 100 according to the first example embodiment, the raw material powder for forming surface protective layer 13 is applied to the outer surface of the unfired ceramic body strip in the step of preparing the unfired ceramic body strip. However, in the second example embodiment, the unfired ceramic body strip is cut into individual ceramic bodies, and then the raw material powder for forming surface protective layer 13 is applied to the outer surface of each unfired ceramic body, such that surface protective layer 13 is also formed on the first end surface and the second end surface of ceramic body 1 to produce multilayer ceramic capacitor 200.

In multilayer ceramic capacitor 200 according to the second example embodiment, the strength of the first end surface and the second end surface of ceramic body 1 is also improved.

The first example embodiment and the second example embodiment have been described above. However, the present invention is not limited to the above-described example embodiments, and various modifications may be made in accordance with the spirit and scope of the present invention.

For example, the material for the ceramic of capacitance forming portion 11, the ceramic of non-capacitance forming portion 12 and the ceramic of surface protective layer 13 of ceramic body 1 described above is merely an example, and other materials may be used.

Further, the configuration (such as a core-shell structure or a composite) of the ceramic included in surface protective layer 13 is also an example, and is not limited to that described above.

In a multilayer ceramic capacitor according to an example embodiment of the present invention, it is also preferable that the composition of the ceramic of the capacitance forming portion is the same as the composition of the ceramic of the non-capacitance forming portion. In this case, the multilayer ceramic capacitor can be manufactured from one type of ceramic green sheet, which improves productivity. Accordingly, it becomes easier to procure, process and manage the material, which further improves productivity.

For example, it is also preferable that the ceramic of the surface protective layer includes Zr. For example, it is also preferable that the ceramic of the surface protective layer includes ZrO₂. For example, it is also preferable that the ceramic of the surface protective layer includes particles which have a core-shell structure and include Zr as a shell on the surface of BaTiO₃. For example, it is also preferable that the ceramic of the surface protective layer includes a composite of ZrO₂ and BaTiO₃. As a result, even if an external force is applied to the ceramic body, it is possible to reduce or prevent more effectively cracks or chips from occurring in ceramic body 1 due to stress-induced phase transition of Zr or ZrO₂.

It is preferable that the average particle size of the ceramic of the surface protective layer is smaller than the average particle size of the ceramic of the non-capacitance forming portion. Thus, the surface protective layer is made from a ceramic having a small average particle size, which further improves the ceramic cutting strength.

It is also preferable that the average particle size of the ceramic of the surface protective layer is, for example, about 0.35 μm or less. Thus, the surface protective layer has high strength.

It is also preferable that the porosity of the ceramic of the surface protective layer is greater than the porosity of the ceramic of the non-capacitance forming portion. Thus, the stress applied to the ceramic body can be dispersed by pores (voids) in the surface protective layer, and therefore the stress can be prevented from being propagated to the non-capacitance forming portion or the capacitance forming portion.

It is also preferable that the average thickness of the surface protective layer is, for example, about 1 μm or more and about 10 μm or less. If the average thickness of the surface protective layer is less than about 1 μm, the surface protection layer may not adequately protect ceramic body 1. If the average thickness of surface protective layer is greater than about 10 μm, the size of ceramic body 1 may become greater than necessary.

In a manufacturing method of a multilayer ceramic capacitor according to an example embodiment of the present invention, it is also preferable that the elemental powder to be applied to the green ceramic body is, for example, Zr.

Alternatively, it is also preferable that the ceramic powder to be applied to the green ceramic body is, for example, ZrO₂. Thus, the surface protective layer can be formed on the ceramic body with high strength.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic body, a first main surface and a second main surface facing each other in a height direction, a first side surface and a second side surface facing each other in a width direction orthogonal or substantially orthogonal to the height direction, a first end surface and a second end surface facing each other in a length direction orthogonal or substantially orthogonal to both of the height direction and the width direction, and ceramic layer, a first internal electrode, and a second internal electrode stacked in the height direction; and
a first external electrode on the first end surface of the ceramic body and a second external electrode on the second end surface of the ceramic body; wherein
the first internal electrode extends to the first end surface and is electrically connected to the first external electrode, and the second internal electrode extends to the second end surface and is electrically connected to the second external electrode;
the ceramic body includes:
a capacitance forming portion generating a capacitance and including the first internal electrode and the second internal electrode facing each other with the ceramic layer interposed therebetween, the capacitance forming portion having a rectangular or substantially rectangular parallelepiped shape including six surfaces;
a non-capacitance forming portion not generating a capacitance and being outside on each of the six surfaces of the capacitance forming portion such that the first internal electrode and the second internal electrode do not face each other with the ceramic layer interposed therebetween; and
a surface protective layer outside on at least a portion of the non-capacitance forming portion and at least exposed from the first main surface, the second main surface, the first side surface, and the second side surface, the surface protective layer including a ceramic with a composition different from a composition of the ceramic of the non-capacitance forming portion.

2. The multilayer ceramic capacitor according to claim 1, wherein a composition of the ceramic of the capacitance forming portion is the same as the composition of the ceramic of the non-capacitance forming portion.

3. The multilayer ceramic capacitor according to claim 1, wherein the ceramic of the surface protective layer includes Zr.

4. The multilayer ceramic capacitor according to claim 3, wherein the ceramic of the surface protective layer includes ZrO₂.

5. The multilayer ceramic capacitor according to claim 3, wherein the ceramic of the surface protective layer includes particles with a core-shell structure and including Zr as a shell on the surface of BaTiO₃.

6. The multilayer ceramic capacitor according to claim 4, wherein the ceramic of the surface protective layer includes a composite of ZrO₂ and BaTiO₃.

7. The multilayer ceramic capacitor according to claim 1, wherein an average particle size of the ceramic of the surface protective layer is smaller than an average particle size of the ceramic of the non-capacitance forming portion.

8. The multilayer ceramic capacitor according to claim 1, wherein an average particle size of the ceramic of the surface protective layer is about 0.35 μm or less.

9. The multilayer ceramic capacitor according to claim 1, wherein a porosity of the ceramic of the surface protective layer is greater than a porosity of the ceramic of the non-capacitance forming portion.

10. The multilayer ceramic capacitor according to claim 1, wherein an average thickness of the surface protective layer is about 1 μm or more and about 10 μm or less.

11. A manufacturing method of a multilayer ceramic capacitor, the method comprising:
preparing an unfired ceramic body including a first main surface and a second main surface facing each other in a height direction, a first side surface and a second side surface facing each other in a width direction orthogonal or substantially orthogonal to the height direction, and a first end surface and a second end surface facing each other in a length direction orthogonal or substantially orthogonal to both of the height direction and the width direction, and the unfired ceramic body including a ceramic green sheet, a conductive paste layer for forming a first internal electrode, and a conductive paste layer for forming a second internal electrode stacked in the height direction;
applying at least one of an elemental powder or a ceramic powder to at least the first main surface, the second main surface, the first side surface, and the second side surface of the green ceramic body;
firing the unfired ceramic body applied with the powder to produce a ceramic body, the ceramic body including a ceramic layer, a first internal electrode, and a second internal electrode stacked in the height direction; and
forming a first external electrode electrically connected to the first internal electrode on the first end surface of the ceramic body and forming a second external electrode electrically connected to the second internal electrode on the second end surface of the ceramic body; wherein
the ceramic body thus produced includes:
a capacitance forming portion generating a capacitance and including the first internal electrode and the second internal electrode facing each other with the ceramic layer interposed therebetween, the capacitance forming portion having a rectangular or substantially rectangular parallelepiped shape including six surfaces;
a non-capacitance forming portion not generating capacitance and being outside on each of the six surfaces of the capacitance forming portion such that the first internal electrode and the second internal electrode do not face each other with the ceramic layer interposed therebetween; and
a surface protective layer being outside on at least a portion of the non-capacitance forming portion and at least exposed from the first main surface, the second main surface, the first side surface, and the second side surface, the surface protective layer including a ceramic with a composition different from a composition of the ceramic of the non-capacitance forming portion.

12. The manufacturing method of a multilayer ceramic capacitor according to claim 11, wherein the elemental powder is Zr.

13. The manufacturing method of a multilayer ceramic capacitor according to claim 11, wherein the ceramic powder is ZrO₂.

14. The manufacturing method of a multilayer ceramic capacitor according to claim 11, wherein a composition of the ceramic of the capacitance forming portion is the same as the composition of the ceramic of the non-capacitance forming portion.

15. The manufacturing method of a multilayer ceramic capacitor according to claim 11, wherein the ceramic of the surface protective layer includes Zr.

16. The manufacturing method of a multilayer ceramic capacitor according to claim 11, wherein the ceramic of the surface protective layer includes ZrO₂.

17. The manufacturing method of a multilayer ceramic capacitor according to claim 15, wherein the ceramic of the surface protective layer includes particles with a core-shell structure and including Zr as a shell on the surface of BaTiO₃.

18. The manufacturing method of a multilayer ceramic capacitor according to claim 16, wherein the ceramic Of the surface protective layer includes a composite of ZrO₂ and BaTiO₃.

19. The manufacturing method of a multilayer ceramic capacitor according to claim 11, wherein an average particle size of the ceramic of the surface protective layer is smaller than an average particle size of the ceramic of the non-capacitance forming portion.

20. The manufacturing method of a multilayer ceramic capacitor according to claim 11, wherein an average particle size of the ceramic of the surface protective layer is about 0.35 μm or less.
